(19) United States
(12) Patent Application Publication
(10) Pub. No.: US 2016/0055531 A1
(43) Pub. Date: Feb. 25, 2016

(54) Marketing of authenticated articles thru social networking

(71) Applicant: Pasquale Vincent Costa, Concord, MA (US)

(72) Inventor: Pasquale Vincent Costa, Concord, MA (US)

(21) Appl. No.: 14/121,347

(22) Filed: Aug. 22, 2014

(51) Int. Cl. G06Q 30/02; G06Q 50/00; G06T 11/60

(52) U.S. Cl. CPC G06Q 30/0257; G06T 11/60; G06Q 50/01

(57) ABSTRACT

A unique virtual hybrid world, operating under the direction and oversight of an Overseer, that defines the rules or conduct, permissible actions and interactions, the virtual habitat construction, permissible personal objects, artifacts, products, etc. All actions or interactions of participants are monitored in a manner sufficient to insure adherence to the allowable conduct and interaction rules and procedures. The virtual habitat is furnished, equipped and stocked with a multitude of items, such as 3D digital representations (facsimiles) of real world personal items, objects, branded products, bulletin boards, photos, texts, videos, audios, and avatars, which reflect the choices and predilections of a location's resident (owner, proprietor, etc.). The manner in which the virtual location resident creates, furnishes, equips and stocks their virtual habitat is so that it may be of great interest to a permitted visitor. The items selected for the virtual habitat can be made up of facsimiles of things they actually possess in the real world or items they aspire to own. The unique virtual hybrid world is accessed by a permitted visitor/participant/user either through a computer browser or via a custom program or application running on a personal computer, tablet computer, smartphone or similar digital device. Every permitted visitor/user is required to have a secure username and password.

### BACKGROUND OF THE INVENTION

1. Field of Application

This invention relates to the display of articles (products) for social purposes including marketing; and more particularly to electronic social networking of virtual articles (products) for article (product) marketing.

2. Description of the Prior Art

Many people like to describe to others, maybe even brag about, articles such as products and other things they possess. Such articles may include: personal items such as clothing, jewelry, cosmetics, etc.; and/or household items such as furniture, decorations, paintings, or the like; and/or other items such as automobiles, landscaping, golf clubs, recreation or similar items. Collections of coins, watches, tea cups and kettles, commemorative plates and the like are also discussed, “shown off” and maybe even bragged about when it's possible to do so. Such articles (products) may include items that are directly owned and under the possession and/or direct control of a person, but also items owned but which may be in a storage facility, bank vault, or off the describer's premises, or otherwise under the control of the party talking about or otherwise showing and/or describing the article.

Sport, movie, theater and political celebrities even, maybe especially, like to increase their fans and followers thru house tours of their homes, which not only include such articles but are often filled with products they actively sponsor in advertisements and commercials; but time is limited and there may be some that don't have the time to actively sponsor as many products as they might want to sponsor.

Likewise, many people like to explore other people's possessions; to pay a visit and wander through some-one else's things and see what things of interest may be found there; and even talk (brag) about what they, themselves, have.

Current technology not only permits, but sometimes pursues, inviting others for a virtual visit and tour of a home, possibly without a persons physical presence. It can all be done, and often is done, on-line.

However, many, mostly unsaid, questions often arises in the thoughts and minds of the party taking the tour and listening about and/or observing the articles. Those questions may go to the authenticity of the article (products) and the veracity of the alleged ownership and/or legal possession.

### SUMMARY OF THE INVENTION

Therefore; It is an object of this invention to provide a new and novel article (product) viewing and marketing system and method.

It is another object of this invention to provide new and novel components that facilitate authenticating the veracity of ownership and of the authenticity of articles (products) for marketing purposes.

It is another object of this invention to provide a new and novel social networking system and method for possible article viewing and/or product marketing.

It is another object of this invention to provide a new and novel social networking system and method which utilizes virtual reality concerning article (product) ownership to facilitate article (product) marketing.

It is another object of this invention to provide a new and novel social networking system and method which utilizes virtual reality concerning article (product) authenticity to facilitate product marketing.

It is another object of this invention to provide a new and novel social networking system and method which stores private information concerning articles (product) ownership to facilitate the owners needs associated with the articles (products) ownership.

The instant invention, will be hereinafter described by way of example so that the above and other objects, features, and advantages of the present invention may be more fully comprehended and appreciated. Reference is made to specific embodiments of the invention, which are illustrated in the appended drawings, wherein like reference characters indicate like parts. It should be understood that the drawings only depict preferred embodiments of the present invention; and are not, therefore, to be considered limiting in scope. Thus, the invention will be described and explained with added specificity and detail through the use of the accompanying drawings.

### BRIEF DESCRIPTION OF THE DRAWING

FIGS. 1-12 show the afore described elements of the invention as well as selected uses of the described system.

### DESCRIPTION OF THE PREFERRED EMBODIMENT

With reference to the drawings there is generally shown at 10 a display which, in this instance, appears as an outline of the rooms in an average home. In this particular example of the inventive subject matter the “special” articles, or things to be illustrated, are articles (products) and things that are usually located in a home environment. It should be understood, nevertheless, that those “special” articles may just as well be found: in an office; a workplace; a storage facility; and/or any other place or any other location that the owner/possessor of the “special” article selects, and where the particular “special” article(s) may best be shown.

Display 10 shows and includes space designations for a virtual closet 12, virtual bedroom 14, virtual front room 16, and virtual bathroom 18. Depending on the number of “special” articles, or things that a party or parties intend to show, display 10 could have more or less virtual rooms. A virtual hobby closet 30, virtual tool closet 32 and virtual garage 34, and/or the like, may be located in an attached section 40 that serves to extend display 10.

In the herein described preferred embodiment each article product, thing, etc to be shown in display 10, or attached section 40, is rendered as “special” by having its possession and/or ownership verified to be that of the inviting party and by having its brand authenticity verified as well. The possession, ownership verification and brand authenticity are best if derived by and through a verification and authentication provided by an independent third party verifier/authenticator 50 according to procedures and rules established by the third party verifier/authenticator 50. After the inviter's ownership is verified and the products brand authenticity has been authenticated its virtual representation image may be placed in display 10 or section 40. A kit (not shown) of suitable marking indicia may be provided to the inviter and under suitable third party supervision and instruction the article made “special”.

To show actual articles in display 10 may, in some instances, require a much greater space then available in displays 10 and 40, and could possibly consume more time than the article (product) possessor (inviter) and party invited may have to tour the articles that the inviter and invitee intend to spend on line together. Accordingly, each “special” article (product) or thing to be displayed, may instead be represented by an image, icon or similar device 44 that would be recognized by the party invited to tour the owner's “special” possessions. Such images, icons, and/or other devices may be as agreed upon by the inviter and the third party 50; or, as suggested by the brand owner for the image to be viewed in display 10. As shown, by way of examples for, the shoe image 44 in closet display section 12 and the shirt image 44 of display section 14.

The virtual image icons shown to be within solid black lines and larger than the rest in its display section are for the “special” articles then being viewed by the invitee. In addition each display section 12, 14, 16, 18, etc. of the respective display sections includes smaller image display spaces 46, 48 as well as left facing and right facing respective arrows 52, 54. Clicking on a left facing arrow 52 will move image 44 to the left to image space 46, image 56 to the left into image space 44 and a new image into space 48. Clicking on right facing arrow 54 will move image in space 44 into space 48, the image in space 46 into space 44 and a new image into space 46. Thus each “special” article may be scrolled through and admired by the invitee. Numbers 47 may be included after each space designation to indicate how many “special” articles are available in that display section.

Each display section, 12, 14, 16, 18, 30, 32, 34, and 40 may also be provided with a chat button 60 which, when clicked, will permit the invitee to send written comments on selected “special” articles; or permit the inviter and invitee to chat about some or all the displayed “special” articles.

In addition each such display section 12, 14, 16, 18, 30, 32, 34 and 40 may be equipped with an “I WANT TO BUY” button 70 which, when clicked, will either connect the invitee to a purchase set up with the brand owner for the respective “special” article or establish a relationship with inviter through which the “special” article may be purchased.

since various changes could be made in the above arrangements and constructions without departing from the scope of the invention, it should be understood that all matter contained in the above description and/or shown in the accompanied claims which follow should be interpreted as illustrative and not in a limited sense.

This Unique Social Network is made up of a 2D and 3D virtual cloud based hybrid ecosystem in which people and organizations, both ordinary and extraordinary, construct virtual habitats (locations), from which they can interact with each other on the basis of mutual needs, desires, common interests, and other incentives.

Each participant's (person, persons, group, organization, etc.) virtual habitat is of their own design, and exists in parallel with their real world habitats. Each participant may “travel” seamlessly between both the virtual and physical worlds. Every participant decides their own path or adventure through this hybrid world based on their needs, desires and interests.

Participants are allowed to travel in this new realm to visit all of the other habitats and areas where they are authorized to visit.

The virtual habitat is furnished, equipped and stocked with a multitude of items, such as 3D digital representations (facsimiles) of real world personal items, objects, branded products, bulletin boards, photos, texts, videos, audios, and avatars, which reflect the choices and predilections of the location's resident (owner, proprietor, etc.). The manner in which the virtual location resident creates, furnishes, equips and stocks their virtual habitat may be of great interest to each visitor. The items they select for their virtual habitat can be made up of facsimiles of things they actually possess in the real world or items they aspire to own.

This unique hybrid world is accessed by a permitted visitor/participant/user either through a computer browser or via a custom program or application running on a personal computer, tablet computer, smartphone or similar digital device. The components of the virtual elements of this social network include computer programs, digital device applications (“apps”), interface computer software, participant personal data/information or participating organization data/information, which resides at central servers and on user personal computers, tablets or mobile devices, all interconnected through telecommunications equipment and systems which facilitate communication and data transfer between the networked participants.

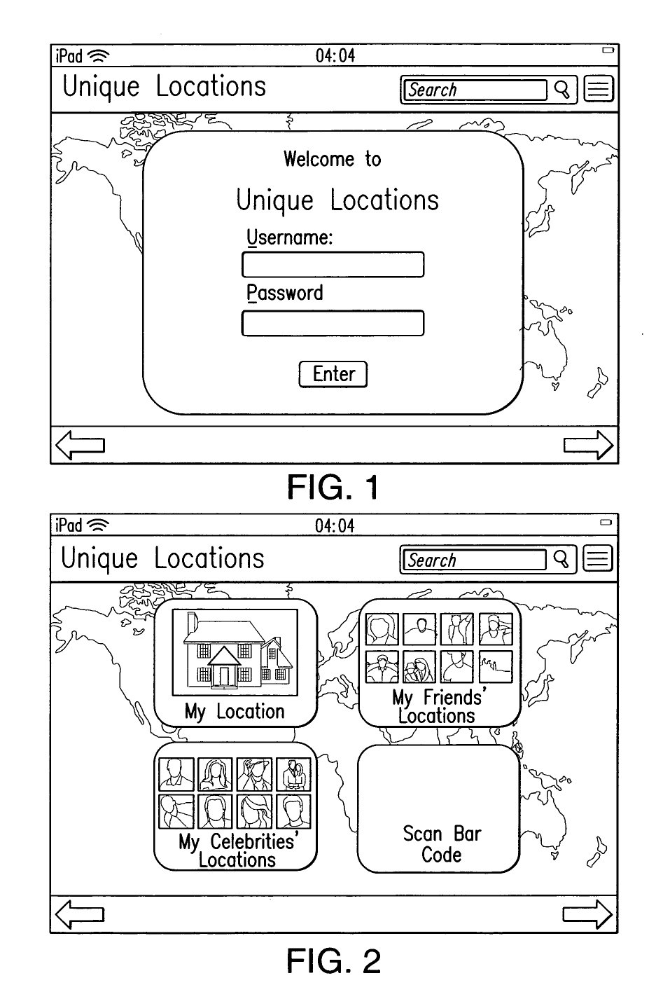

Log-in (FIG. 1) Every permitted visitor/user is required to have a secure username and password. The design of this Unique Social Network establishes a universal place for anyone to socially network about people, places, and things. Although technologically advanced, the application has a simple user interface

Master System Overseer This unique hybrid world operates under the direction and oversight or Master System Overseer which defines the rules or conduct, permissible actions and interactions, the virtual habitat construction, permissible personal objects, artifacts, products, etc. All actions or interactions by the participants are monitored in a manner sufficient to insure adherence to the allowable conduct and interaction rules and procedures.

Main Features—Home Screen (FIG. 2) From the home screen on their digital device visitors/users, after a sign-in procedure, are presented with a menu or choices which help them plan and then embark or their “adventure” through this hybrid world. Participants will select which friends, celebrities or organization's habitats they wish to visit and explore.

When in the real world and using their mobile device “app”, visitors/users can interface the real and virtual worlds by scanning a unique indicia, and/or UPC codes on products or physical locations for several purposes: to instruct the Master System Overseer to add a virtual 3D facsimile image (stored in the Network's server Data Bases) to add the scanned item to their own unique habitat in the virtual world; to see which of their friends who are also network participants wants/owns that or similar items; to see which celebrities own or are endorsing a product similar to the item being scanned; to verify ownership and/or authenticity of products.

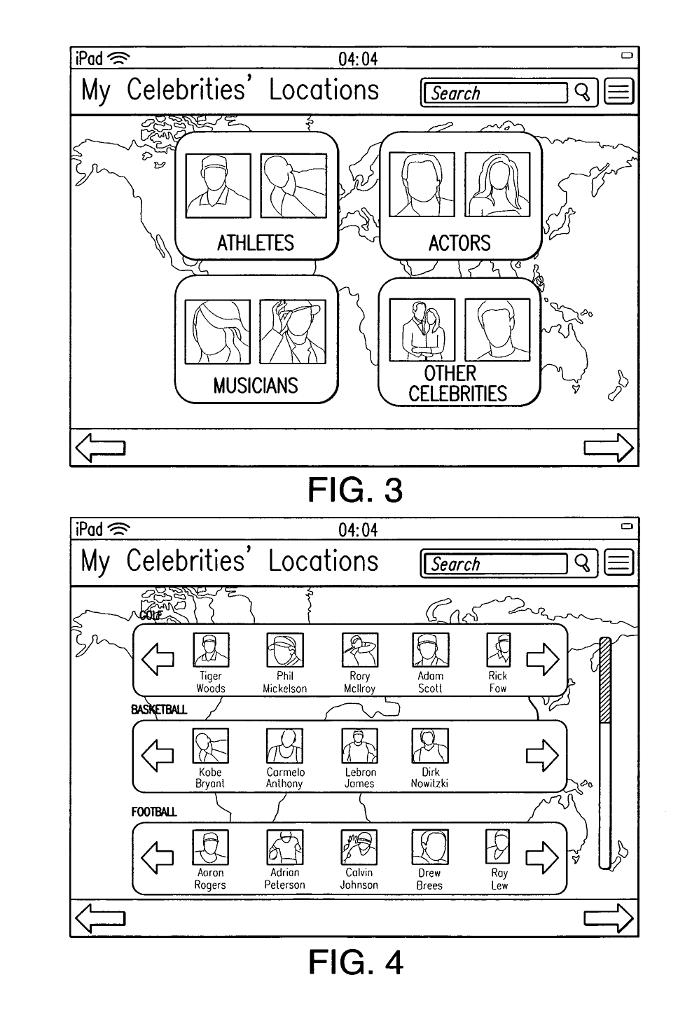

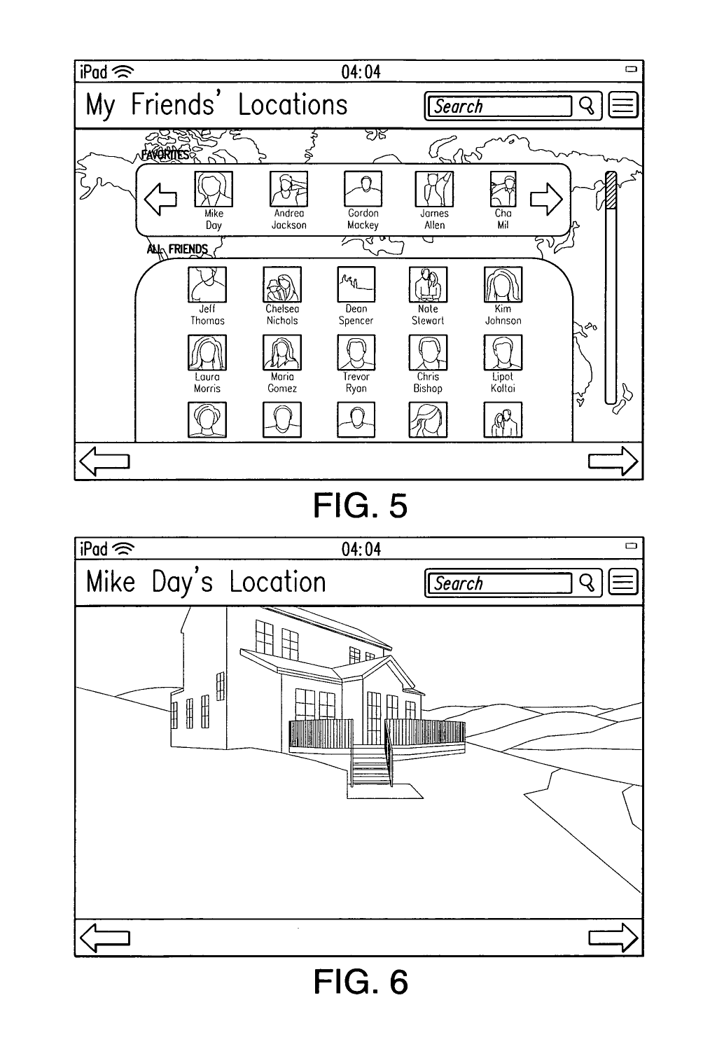

Participant Favorites (FIGS. 3-5) The Unique Social Network “remembers” each visitor/users' favorite celebrities for a variety of categories: Athletes, Musicians, Actors, etc. Each celebrity category can be broken down even further; i.e. what sport a celebrity athlete plays. The concept of storing favorites and creating subgroups for quick access can be applied to friends as well.

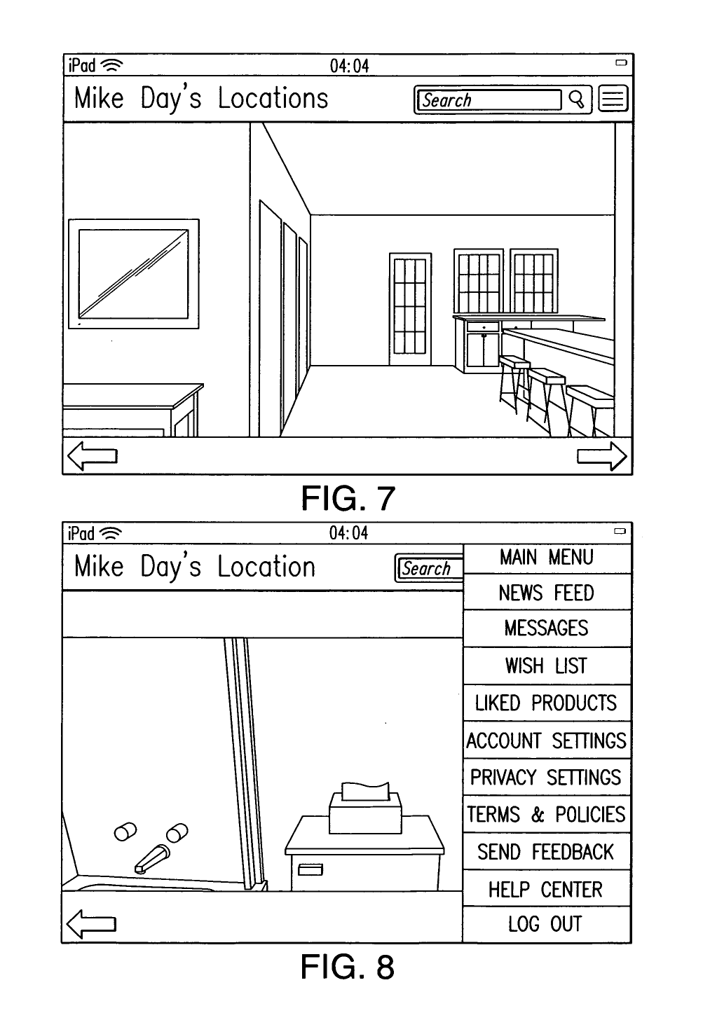

Mobility (FIGS. 6-7) Upon visiting another individual's Unique Habitat there is no pre-prescribed navigation path; the visitor/user has the ability to move freely through and around the place. However, user mobility is restricted by walls and other three-dimensional objects. While in someone's Unique Location, the visitor/user must navigate around objects and from room to room. Navigation functions allow the visitor/user to move in every direction on the ground. Everything is seen in a first-person view; the view can swivel in any direction—while moving or stationary.

Options (FIG. 8) Visitors/Users can access Unique Social Network options at any time.

At the participant's request, the System Overseer will insure that all previous network travel, visits, and actions and interactions history is made available to the participant for any purpose including planning new travel and adventures.

Participants can design news feeds to see what locations friends/celebrities have visited (if those participants wish to disclose said travels) and what items their friends/celebrities have recently shown interest in/purchased. News feeds can alert a participant when a friend or celebrity changes something in their location. Strong privacy settings allow visitors/users to decide what information to share and with whom they share that information.

They can perform other functions like updating personal descriptions, make personal habitat design changes, update credit card or payment information for quick item purchases.

Participants design their own Unique Habitat Each participant determines the type of virtual habitat and its virtual spaces or subspaces included:

Home, with its sublocations of living room, kitchen, bedroom, etc.

Apartment

Vacation home

Boat.

Car

Club

Garage

Shed

Each participant determines the relative size and location of the virtual spaces and subspaces. Participants decide what personalized decorations to add to their location, e.g., personal pictures, text, audios, or videos. Participants determine what to call their virtual habitat or location, e.g., Moe's Vacation Getaway. Participants are given a standard allowance to “construct” their virtual Unique Location. Through Unique Location activity, a participant can earn a more elaborate location. Alternatively, a participant can request and pay the System Master Overseer function for a more elaborate location. A participant can also contract out to an approved “builder” to create a custom location for the participant.

Exterior of a UNIQUE LOCATION Participants have the ability to build their own habitats/locations, and design what colors and materials to display for the floors, walls, etc. of the interior and exterior. If the participant doesn't wish to build/design their own Unique Location, one of several Unique Location 3D home templates may be selected. Unique Locations are set on the virtual ground of their location's “plot” of land or they can situate their location at a map or satellite image of locations where they reside. Participants have the option to put landscaping around their plot of land. A backdrop may be placed into the virtual world to make the user's place appear to be within the setting of that backdrop. Lights and shadows are incorporated into the virtual world to create an even more life-like experience. The user can select the weather to be used for their own place, which can reflect actual weather at that location. Alternatively the owner of a place can create a custom weather pattern.

Interior of a UNIQUE LOCATION The interior of a UNIQUE Habitat/Location is filled with to-scale 3D models of physical items. While navigating through someone's location, doors open automatically for the visitor/user, allowing a seamless transition from room to room. Lights also turn on/off automatically as users enter/exit rooms. A user has the option to have chosen music automatically play when someone visits their place. Users may place the 3D models of their physical items or other personal items wherever they wish, within their UNIQUE Habitat/Location area (inside or outside).

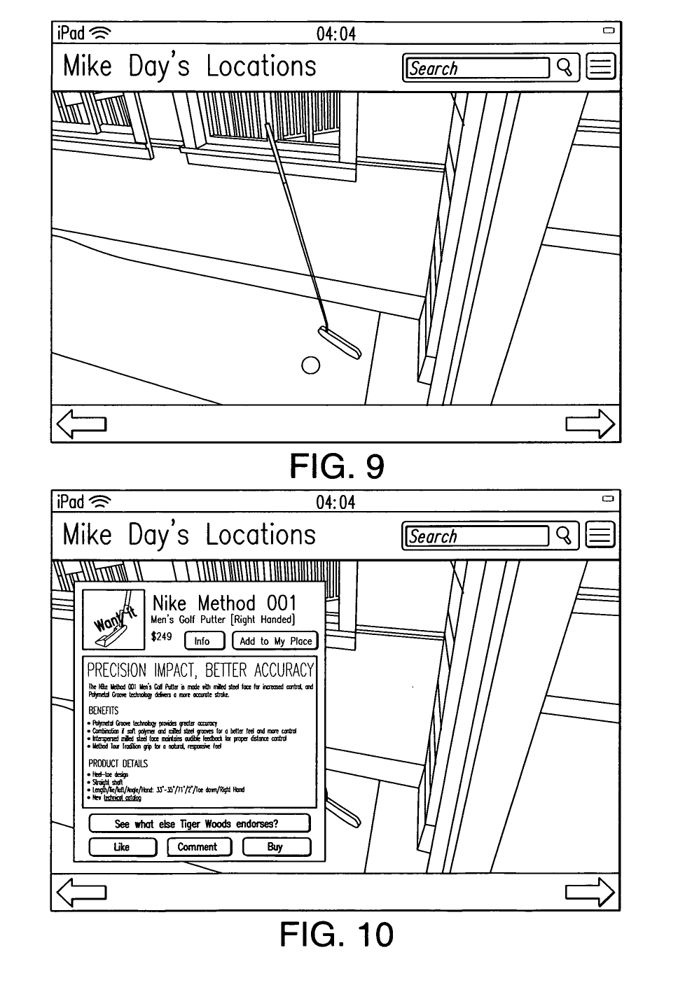

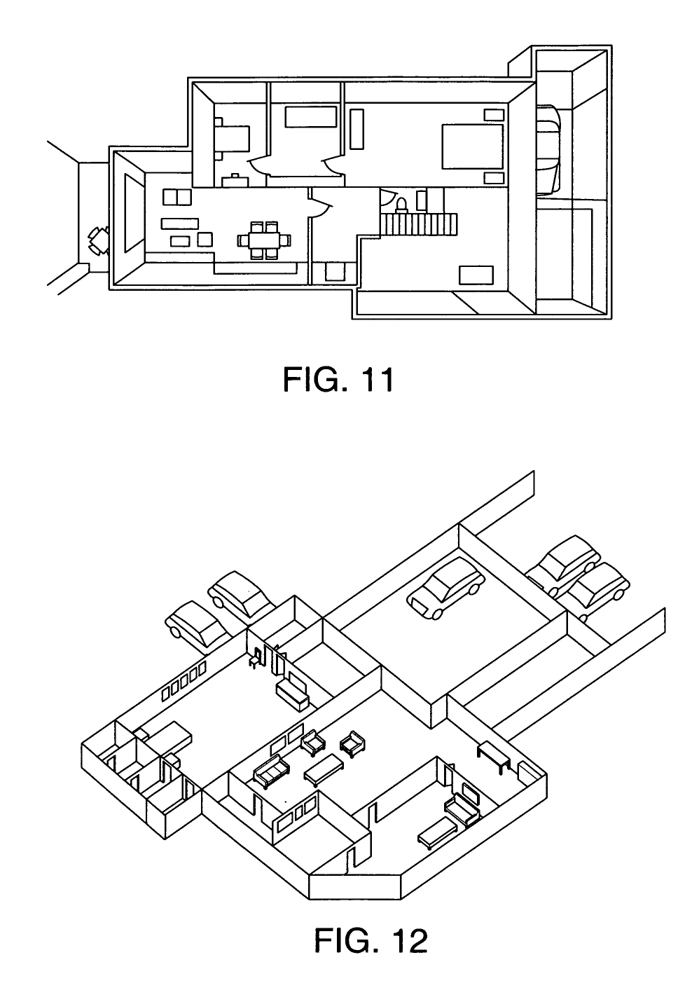

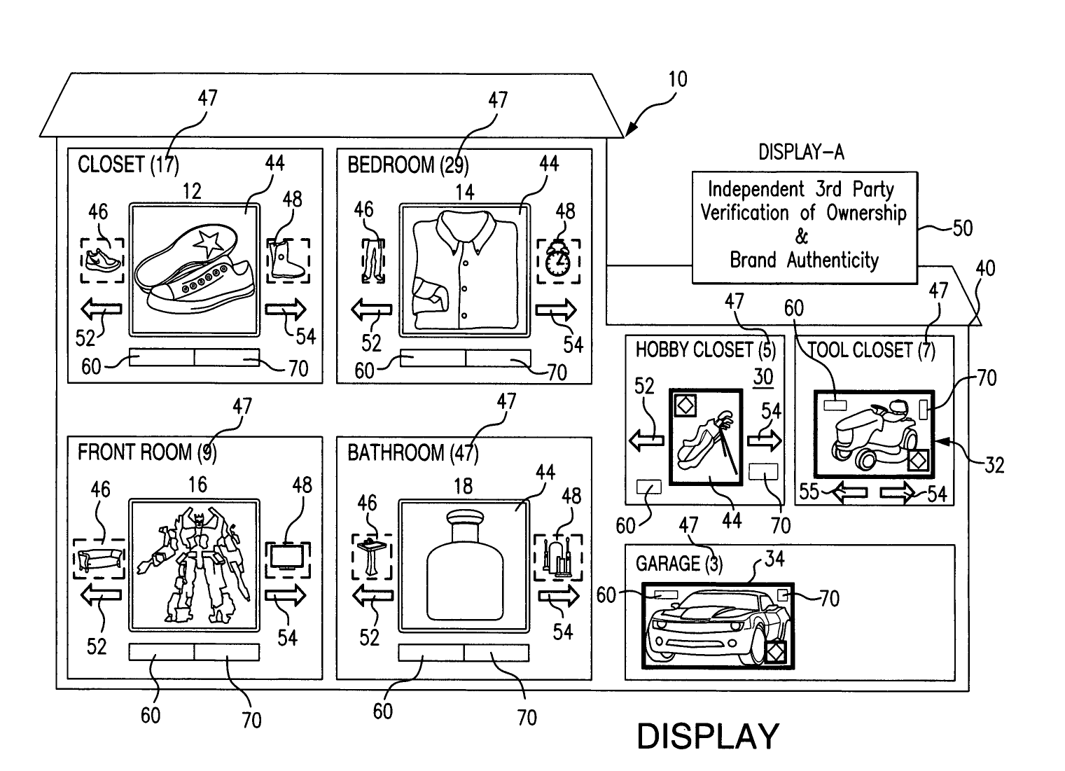

Viewing and Handling of Objects (FIGS. 9-10) Plan and Perspective View (FIGS. 11-12) While touring through someone's location, the user may select an object to raise the item to their line of sight and rotate the item to view from any angle: The 3D imagery they will see will have been provided through the Master System Overseer function. Commercially available product imagery will have been created by the Product Brand Source Organization, stored in the Network Server's database, and delivered on demand to a habitat as requested by its owner/designer. While viewing an item, the user can access more information about the item and is given the option to buy the item. When the user is done viewing the item, it is automatically returned to its designated location. 3D objects are not transportable throughout the house by anyone except the owner of that Unique Location. While visiting someone else's location, a user's interactions are limited to touring around the house and viewing items. (with the option to add comments, purchase, add to a wish list or leave notes or messages on the Locations “bulletin board” or guest book). Only the owner of each Unique Habitat/Location is allowed to add, move or remove items from the location.

Avatars Celebrities can create avatars which represent the image they wish to portray to users. These avatars are complex 3D models, able to move like humans, speak and respond to user actions or inquiries. For example, a celebrity's avatar could respond to the re-entrance into their place of a fan, who has been away for a while by saying, “Hello Aaron. I'm glad to see you again. I missed you, but I'm so happy that you are here now. I just completed a new single. Would you like to hear it?” If the user responds yes, then the celebrity's avatar sings their latest single. If the response is no or after a pause with no response, the celebrity's avatar could say, “Aaron, would you like to see what I bought on my last shopping trip?”

Users can also create their own avatars. Users can hold virtual meetings among their avatar and their friends' avatars at a public place or one of the users' Locations.

Brand and Celebrity Involvement In the case of products that are added by a person or celebrity, participating brand manufacturers of a selected or scanned product will provide the 3D imagery of that product. (Brands should be motivated to provide high quality image/models of their products to be placed or “endorsed” in this virtual world to promote sales.) Brands will also use data based on selection or “click rates” to analyze market trends etc.

What is claimed is:

1. A system to enable possessors of “special” articles to display such articles on-line in a social network to specific social network invited participants (invitees); comprising
a. providing at least one article;
b. providing at least one display;
c. rendering that said at least one article to be “special” by,
i. providing verification that said at least one article is rightfully possessed by a display owner; and
ii. providing authentication that said at least one article is brand authenticated;
d. providing a display for said at least one “special” article;
e. providing an image, icon or the like representing said at least one “special” article;
f. inserting said image, icon or the like into said display;
g. entering said display with said at least one “special” article image into a selected social network; and
h. inviting a party through said social network to view said at least one “special” article image.

2. The system of claim 1 wherein the article possessor is an owner of the article.

3. The system of claim 1 wherein there are a number of said “special” article images.

4. The system of claim 2 wherein said images, icons or the like are virtual.

5. The system of claim 1 wherein said display for each said virtual image includes a communication device indicating that the respective invitee would like to purchase the “special” article of said virtual image, and which, in addition, establishes a means to do so.
